(19) United States
(12) Patent Application Publication
(10) Pub. No.: US 2025/0068537 A1
(43) Pub. Date: Feb. 27, 2025

(54) SERVER TESTING METHOD, TESTING PLATFORM, AND STORAGE MEDIUM

(71) Applicant: Fulian Precision Electronics (Tianjin) Co., Ltd., Tianjin (CN)

(72) Inventors: TENG-FEI MA, Tianjin (CN); Jie Yuan, Tianjin (CN)

(21) Appl. No.: 18/490,781

(22) Filed: Oct. 20, 2023

(30) Foreign Application Priority Data
Aug. 23, 2023 (CN) 202311076120.5

(51) Int. Cl. G06F 11/34; G06F 11/30

(52) U.S. Cl. CPC G06F 11/3409; G06F 11/3006

(57) ABSTRACT

A server testing method applied to a testing platform is provided. The testing platform is communicatively connected to a server, the server includes a plurality of processing units and a plurality of switches, the plurality of processing units is interconnected to the plurality of switches according to a topological structure. The server testing method includes obtaining an updated topological structure, by updating the topological structure via updating firmware of the plurality of switches based on a target firmware upgrade package; and generating a test result by controlling the server to perform a target test task corresponding to the updated topology structure. The present application further provides a testing platform, a testing device, and an external storage medium.

### FIELD

The present application relates to the field of testing technology, and in particular to a server testing method, a testing platform, a testing device and a storage medium.

### BACKGROUND

In recent years, high tech industries such as artificial intelligence (AI), Internet of Things, cloud computing, and big data have developed rapidly. In order to meet collections and arrangements of various data in fields of the high tech industries, AI servers using various heterogeneous forms are widely used, which put higher demands and challenges on the computing power of AI servers. The benchmark performance test of inference of the deep learning model of the AI computing platform is a main reference indicator for measuring the computing power of the AI servers.

At present, the general practice for the benchmark performance test of the inference of the deep learning models of the AI computing platform is to manually configure basic deep learning environment and deep learning framework based on difference of hardware configurations especially GPU models of the server. In the process of configuring dozens or even hundreds of servers, there are shortcomings such as repeated installation of the basic deep learning environment and deep learning framework, error-prone, time consuming and labor-intensive, which consume human resources. In addition, the benchmark performance test of the deep learning framework of the AI computing platform and the analysis and compilation of test results also need to be performed manually, which is not only a heavy workload, but also time-consuming and labor-intensive.

### BRIEF DESCRIPTION OF THE DRAWINGS

The above and/or additional aspects and advantages of the present disclosure will become apparent and comprehensible from the description of the embodiments in conjunction with the following drawings:

FIG. 1 is a schematic structural diagram of a testing device according to an embodiment of the present application.

FIG. 2 is a schematic structural diagram of a testing platform testing a server according to an embodiment of the present application.

FIG. 3 is a flow chart of a server testing method according to an embodiment of the present application.

### DETAILED DESCRIPTION

Embodiments of the present application are described in detail below, examples of which are illustrated in the accompanying drawings, same or similar reference numerals represent same or similar elements or elements with the same or similar functions. The embodiments described below with reference to the drawings are exemplary and are only used to explain the present application and cannot be understood as limiting the present application.

Many specific details are set forth in the following description in order to fully understand the present application. The described embodiments are only some, but not all, of the embodiments of the present application. Based on the embodiments of the present application, all other embodiments obtained by those of ordinary skill in the art without creative efforts fall within the scope of protection of the present application.

In the description of the present application, unless defined otherwise, all technical and scientific terms used herein have the same meanings as commonly understood by a person skilled in the art to which the application belongs. The terminology used herein in the description of the application is for the purpose of describing specific embodiments only and is not intended to limit the application.

In the embodiments of the present application, it should be noted that, unless otherwise explicitly stated or limited, words such as exemplary or for example are used to represent examples, illustrations or explanations. Any embodiment or design described as “exemplary” or “for example” in the embodiments of the present application is not to be construed as preferred or advantageous over other embodiments or designs. Rather, use of words such as “exemplary” or “for example” is intended to present related concepts in a concrete manner. In the case of no conflict, the following embodiments and features in the embodiments can be combined with each other.

In the embodiments of the present application, it should be noted that, unless otherwise explicitly stated and limited, terms “installation” and “connection” should be understood in a broad sense. For example, it can be a fixed connection or a detachable connection; it can be a mechanical connection, an electrical connection or mutual communication; it can be a direct connection or an indirect connection through an intermediate medium; it can be an internal connection between two components or an interaction relationship between two elements. Those of ordinary skill in the art can understand the specific meanings of the above terms in the present application according to specific situations.

The following disclosure provides many different embodiments or examples for implementing the various structures of the present application. To simplify the disclosure of the present application, the components and arrangements of specific examples are described below. Of course, they are merely examples and are not intended to limit the application. Furthermore, the present application may repeat reference numbers and/or reference letters in different examples, such repetition being for the purposes of simplicity and clarity and does not by itself indicate a relationship between the various embodiments and/or arrangements discussed.

In order to more clearly understand the above objects, features and advantages of the present application, the present application will be described in detail below in conjunction with the accompanying drawings and specific embodiments. It should be noted that, in the case of no conflict, the embodiments of the present application and the features in the embodiments can be combined with each other.

The present application takes an AI (Artificial Intelligence) server as a test object, and describes a server testing method, a testing platform, a testing device, and an external storage medium provided in the embodiments of the present application.

In order to meet the collections and organizations of various data in fields of high tech industries such as artificial intelligence, Internet of Things, cloud computing and big data, the AI servers using various heterogeneous forms are widely used, which put forward the higher demands and challenges of the data processing capabilities of the AI servers.

The interconnection of CPU and GPU is a commonly used combination of processing units in AI servers. NVIDIA has launched three basic PCIe topologies for the interconnection between CPU and GPU, namely balance mode, common mode, and cascade mode. AI servers have different topologies for different application scenarios. The computing power in the balanced mode in most application scenarios is similar to that of the common mode. It is impossible to make a better choice of a topology model based on the application scenario alone. The P2P performance of GPU is different in different modes, and the degree of utilization of CPU resources is also different.

Obviously, different application scenarios have different actual requirements for processing units. Due to space and operation limitations, a server often does not support the simultaneous design of multiple processing unit architectures. For different application scenarios, designing automated testing methods for AI servers to detect whether server performance with different topology configurations meets standards is of great significance for optimizing server computing resource configuration.

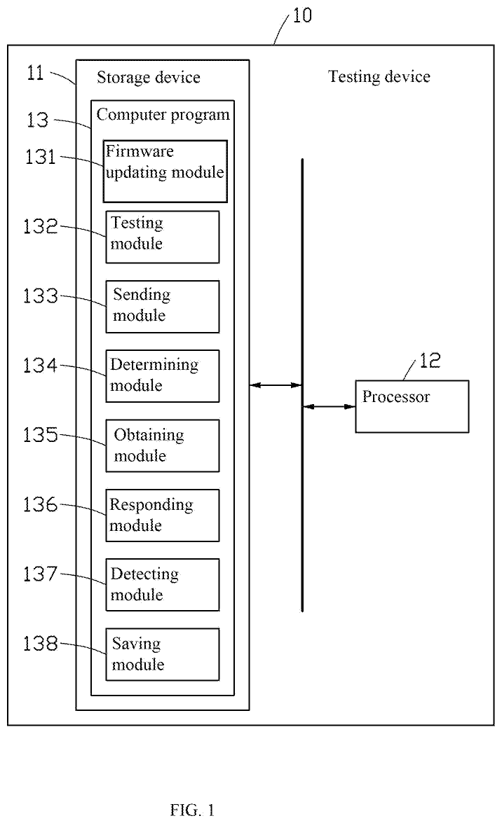

Please refer to FIG. 1 to FIG. 3, in order to solve the above problems, embodiments of the present application provide a server testing method, a testing platform 100, a testing device 10 and a storage medium 40 externally connected to the testing device 10 (the storage medium 40 hereinafter is referred to as “external storage device”). The server testing method according to the embodiment of the present application can be applied to the testing platform 100 including the testing device 10. The following is an introduction based on the application scenarios according to the embodiments of the present application.

Please refer to FIG. 1, which is a schematic structural diagram of the testing device 10 according to an embodiment of the present application.

As shown in FIG. 1, the testing device 10 includes, but is not limited to, a storage device 11, a processor 12, and a computer program 13 stored in the storage device 11 and executable by the processor 12. The computer program 13 can be a test program used for testing the AI server.

Exemplarily, the computer program 13 can be divided into one or more modules/units, for example, a firmware updating module 131, a testing module 132, a sending module 133, a determining module 134, an obtaining module 135, a responding module 136, a detecting module 137, and a saving module 138. The one or more modules/units are stored in the storage device 11 and executed by the processor 12 to complete the present application. The one or more modules/units may be a series of computer program instruction segments capable of completing specific functions, and the instruction segments are used to describe the execution process of the computer program 13 in the testing device 10.

The hardware of the testing device 10 may include, but is not limited to: microprocessor, an application specific integrated circuit (ASIC), a (FPGA), a digital signal processor (DSP), embedded devices, etc.

The testing device 10 may be an embedded chip such as an STM32 microcontroller, a PIC microcontroller, an 8051 microcontroller, or an AVR microcontroller. The present application does not limit the type of the testing device 10.

A network where the testing device 10 is located includes, but is not limited to: the Internet, a wide area network, a metropolitan area network, a local area network, a virtual private network (VPN), etc.

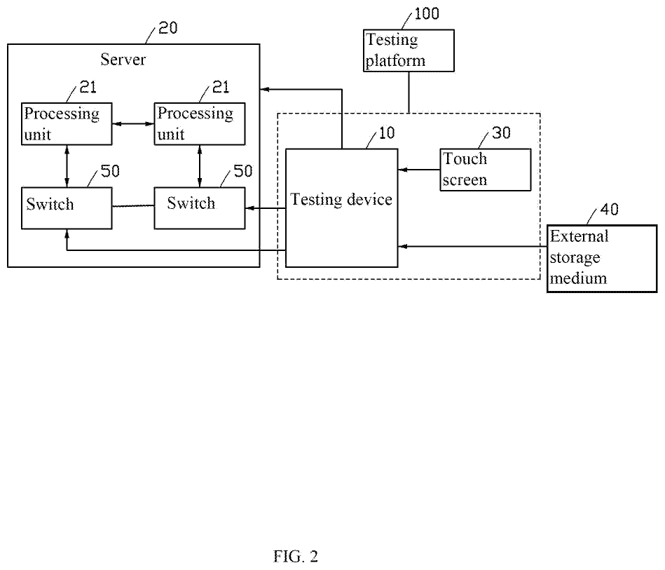

Please refer to FIG. 2, which is a schematic structural diagram of the testing platform 100 according to one embodiment of the present application.

As shown in FIG. 2, the testing platform 100 includes the testing device 10. The testing device 10 is communicatively connected with the server 20. For example, the testing device 10 may be communicatively connected to the server 20 through a USB port. The server 20 may be an AI server. The server 20 includes a plurality of processing units 21 and a plurality of switches. The plurality of processing units 21 and the plurality of switches 50 are interconnected according to a topological structure. The testing device 10 is communicatively connected to the plurality of switches 50. For example, the testing device 10 may be communicatively connected to the plurality of switches 50 through a UART port or an I2C bus interface. The plurality of processing units 21 may include CPUs and GPUs.

The firmware updating module 131 is configured to update the topological structure by updating firmware of the plurality of switches 50 based on a target firmware upgrade package, such that an updated topological structure is obtained. The testing module 132 is used to determine, from the N test task, a test task corresponding to the updated topological structure as a target test task, and control the server 20 to execute the target test task and generate a test result.

In this embodiment, the testing device 10 may be a STM32F407 microcontroller that supports functions of a USB Host and a USB device. In other embodiments of the present application, other embedded chips may be used to replace the testing device 10 according to actual needs.

In different application scenarios, the testing platform 100 first obtains the updated topological structure by updating the topological structure of the server 20 via updating the firmware of the plurality of switch 50 using the firmware updating module 131, and then controls the server 20 to execute the target test task corresponding to the updated topological structure and generates the test result using the testing module 132, so as to evaluate a performance of the server 20 according to the test result. The testing platform 100 can automatically test the server 20 for different application scenarios to achieve comprehensive and accurate performance testing, thereby enabling the server 20 to have better performance, the present application improves a testing efficiency, and saves manpower.

In some embodiments of the present application, the sending module 133 is used to copy test information to the server 20 before updating the firmware of the plurality of switches 50 based on the target firmware upgrade package. The test information includes N topology information and N test tasks, each topology information of the N topology information corresponds to one test task of the N test tasks, the N is a positive integer greater than or equal to 1.

In some embodiments of the present application, the determining module 134 is configured to determine the target firmware upgrade package from N firmware upgrade packages based on a level of a version number corresponding to each of the N firmware upgrade packages before updating the firmware of the plurality of switches 50.

For example, the version numbers corresponding to the N firmware upgrade packages are V1, V2, V3, . . . , Vn, and the levels of the version numbers are in an order from low to high, i.e., V1, V2, V3, . . . , Vn.

In this embodiment, the higher the version number, the newer the version of the firmware upgrade package. For example, the determining module 134 can determine that the firmware upgrade package corresponding to V1 is the target firmware upgrade package from the N firmware upgrade packages, and can determine V2 is the target firmware upgrade package when the N firmware upgrade packages does not include the firmware upgrade package corresponding to V1.

In some embodiments of the present application, the determining module 134 is also configured to determine whether each of the N firmware upgrade packages has been determined as the target firmware upgrade package after controlling the server 20 to perform the target test task.

If at least one firmware upgrade package of the N firmware upgrade packages has not been determined as the target firmware upgrade package, the determining module 134 is further configured to determine one of the at least one firmware upgrade package as a current target firmware upgrade package. The firmware updating module 131 is also configured to obtain a current updated topological structure by updating current firmware of the plurality of switches 50 based on the current target firmware upgrade package. The testing module 132 is further used to control the server 20 to perform one test task of the N test tasks that is corresponding to the current updated topological structure until the firmware of the plurality of switches 50 are updated based on each of all the N firmware upgrade packages and all of the N test tasks have been performed, and then the test is end.

In some embodiments of the present application, the obtaining module 135 is configured to obtain the N topology information before copying the test information to the server 20. The responding module 136 is configured to create the test task corresponding to each of the N topology information in response to user input.

In some embodiments of the present application, the detecting module 137 is used to detect whether a running environment of the server 20 meets a requirement of a test environment before controlling the server 20 to execute the target test task.

For example, detecting whether the running environment of the server 20 meets the requirement of the test environment may include, but is not limited to, detecting whether a software or an application installed on the server 20 is the same as or similar to a software or an application required in the test environment. The software or the application can be used to execute the target test task. The software or the application required in the test environment can be predetermined by the detecting module 137.

In some embodiments of the present application, if the running environment of the server 20 does not meet the test environment requirements, the sending module 133 is further used to copy an environment configuration tool to the server 20 and install the environment configuration tool to the server 20 to execute the target test task. The environment configuration tool can be prestored in external storage medium 40. For example, the environment configuration tool can include a testing software such as CUDA toolkit that can be used to execute target test task.

For example, if the server 20 does not have the software or application required to perform the target test task, it means that the running environment of the server 20 does not meet the requirement of the test environment.

In some embodiments of the present application, the saving module 138 is configured to save the test result after the test result is generated, so as to evaluate the performance of the server 20 based on the test result.

For example, the test result includes performance parameters related to the GPU and the CPU, and the performance parameters include P2P data between GPUs, a measured bandwidth of GPU, a measured bandwidth between the CPU and the GPU, memory bandwidth data, etc.

In this embodiment, the testing platform 100 further includes a touch screen 30, and the touch screen 30 is communicatively connected to the testing device 10. The touch screen 30 can be used to respond to user operations.

In the above embodiment, the touch screen 30 can generate a test instruction in response to user input through the touch screen 30 and can send the test instruction to the testing device 10. That is, the present application has characteristics of convenient interaction, beautiful interface, responsive response, precise control, and accurate output. In addition, the touch screen 30 can also be used to visualize a testing process, reducing the user's operational difficulty with an interactive graphical interface, so as to further improve the testing efficiency and save labor costs.

This embodiment of the present application further provides an external storage medium 40, which is connected to the testing device 10. The external storage medium 40 stores the test information, the test result, and the environment configuration tool. For example, the external storage medium 40 may include any entity or device capable of carrying computer program code, a USB flash drive, a memory card, etc.

In the above embodiment, the external storage medium 40 is used to the environment configuration tool for building the test environment, the test information, and the test result generated by executing the target test task, thereby saving the time of on-site debugging and further improving the test efficiency.

In the above embodiment, the testing device 10 can communicate with the server 20 through the USB port, and then perform functions of file transfer and system control between the testing device 10 and the server 20, which can be easily deployed. The automated testing of the server 20 has strong applicability, small module size, and no usage restrictions, which reduces the difficulty of user training, improves testing efficiency, and saves labor costs and testing resources.

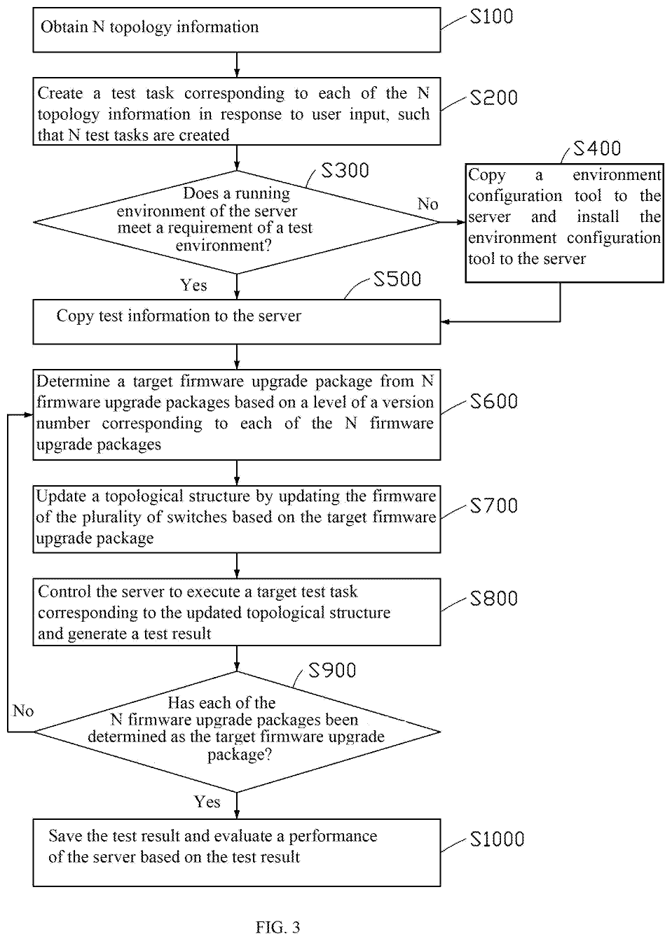

Please refer to FIG. 3, which is a flow chart of a server testing method according to an embodiment of the present application. In the present application, according to different needs, the order of each block in the flow chart can be adjusted according to actual requirements, and some blocks can be omitted.

In this embodiment, the execution subject of the server testing method may be the testing device 10 shown in FIG. 1, and the server testing method is used for testing the server 20. This embodiment takes the communication connection between the testing device 10 and the server 20 through the USB port as an example. The server 20 includes the plurality of processing units 21 and the plurality of switches 50, and the plurality of processing units 21 and the plurality of switches 50 are interconnected according to a topological structure. The testing device 10 can be communicatively connected to each switch 50 through a UART port or an I2C bus interface. Each processing unit 21 may be a CPU or a GPU.

The server testing methods include following blocks.

Block S100, the testing device 10 obtains the N topology information.

In one embodiment, the N topology information are used for different application scenarios. Each of the N topology information indicates a topology structure between the plurality of processing units 21 and the plurality of switches 50.

Block S200, the testing device 10 creates a test task corresponding to each of the N topology information in response to user input, such that N test tasks are created.

Specifically, the touch screen 30 can generate a test instruction related to the N topology information in response to user input through the touch screen 30 and can send the test instruction to the testing device 10. The testing device 10 can create the N test tasks when the test instruction is received.

Block S300, the testing device 100 determines whether the running environment of the server 20 meets the requirement of the test environment.

Specifically, detecting whether the running environment of the server 20 meets the requirement of the test environment may include, but is not limited to, detecting whether a software or an application installed on the server 20 is the same as or similar to that of the test environment.

For example, if the server 20 does not have the software or application required to perform the target test task, the testing device 100 determines that the running environment of the server 20 does not meet the requirement of the test environment.

In some embodiments, if the running environment of the server 20 does not meet the requirement of the test environment, the process goes to block S400, and the testing device 10 copy the environment configuration tool to the server 20 and install the environment configuration tool to the server 20.

In some embodiments, if the server 20 has the software or application required to perform the target test task, the testing device 10 determines that the running environment of the server 20 meets the requirement of the test environment.

In some embodiments, if the running environment of the server 20 meets the requirement of the test environment, the process goes to block S500 and the test information is copied to the server 20.

Block S400, the testing device 10 copies the environment configuration tool to the server 20 and install the environment configuration tool to the server 20.

In one embodiment, the environment configuration tool can include the testing software such as CUDA toolkit.

Block S500, the testing device 10 copies the test information to the server 20.

Specifically, the test information includes the N topology information and the N test tasks, and each topology information of the N topology information corresponds to one of the N test tasks, N is a positive integer greater than or equal to 1.

Block S600, the testing device 10 determines the target firmware upgrade package from N firmware upgrade packages based on the level of the version number corresponding to each of the N firmware upgrade packages.

For example, the version numbers corresponding to the N firmware upgrade packages are V1, V2, V3, . . . , Vn, and the levels of the version numbers are in an order from low to high, i.e., V1, V2, V3, . . . , Vn.

In this embodiment, the higher the version number, the newer the version of the firmware upgrade package. Then the testing device 10 can determine that the firmware upgrade package corresponding to V1 as the target firmware upgrade package. When the process is return to block S600, the testing device 10 can determine that the firmware upgrade package corresponding to V2 as the target upgrade package, and so on.

Block S700, the testing device 10 updates the topological structure by updating the firmware of the plurality of switches 50 based on the target firmware upgrade package, obtaining an updated topological structure.

Specifically, updating the firmware of the plurality of switches 50 based on the target firmware upgrade package includes: updating switch settings and attribute settings of uplink ports and downlink ports of the plurality of switches 50 to adjust a number of GPUs participating in a calculation, and adjusting an interconnection relationship between the GPU and the CPU so as to complete an update of the topological structure, the GPU connects to the CPU through the plurality of switches 50.

Block S800, the testing device 10 controls the server 20 to execute a target test task corresponding to the updated topological structure and generate the test result.

Specifically, the testing device 10 controls the server 20 to call a test task, that is, the target test task corresponding to the updated topological structure, and then executes the target test task and generates test results.

Block S900, the testing device 10 determines whether each of the N firmware upgrade packages has been determined as the target firmware upgrade package.

In some embodiments, if at least one firmware upgrade package of the N firmware upgrade packages has not been determined as the target firmware upgrade package, it indicates that at least one test task of the N test tasks has not been completed, and the testing device 10 needs to perform blocks S600-S800 again, the test ends until the firmware of the plurality of switches 50 is updated based on each of all the N firmware upgrade packages and the test task corresponding to the updated topological structure is completed.

In some embodiments, if each of the N firmware upgrade packages has been determined as the target firmware upgrade package, it indicates that the N test tasks have been completed, that is, N topological structures of the server 20 have been tested, and then the test can be ended.

Block S1000, the testing device 10 saves the test result and evaluates a performance of the server 200 based on the test result.

For example, the testing device 10 executes a save instruction to save the test result to the external storage medium 40. At the same time, the touch screen 30 is used to visualize the test process and test result, so as to facilitate the performance of the server 20 is evaluated based on the test result.

In different application scenarios, the server testing method of this example implementation first updates the topology structure of the server 20 by updating the firmware of the plurality of switches 50, then controls the server 20 to perform the target test task corresponding to the updated topological structure, and finally generates the test result, the performance of the server 20 is evaluated based on the test result. The server testing method can be performed automatically on the server 20 for different application scenarios to achieve comprehensive and accurate performance testing, thereby enabling the server 20 to perform better, the testing efficiency is improved, and manpower is saved.

In one embodiment, the processor 12 of the testing device 10 shown in FIG. 1 may be a central processing unit (CPU), or other general purpose processors, digital signal processor (DSP), application specific integrated circuit (ASIC), field-programmable gate array (FPGA) or other programmable logic devices, discrete gate or transistor logic devices, discrete hardware components, etc. The general purpose processor may be a microprocessor. The processor 12 can also be any conventional processor. The processor 12 is a computing core and a control center of the testing device 10, and uses various interfaces and lines to connect various parts of the testing device 10, and obtain the operating system, various installed applications, program codes of the testing device 10, etc.

The processor 12 obtains the operating system of the testing device 10 and various application programs installed in the testing device 10. The processor 12 obtains the application program to implement the blocks in each of embodiments of the server testing method, such as the blocks shown in FIG. 3.

The storage device 11 can be used to store a computer program 13 and/or modules. The processor 12 executes or obtains the computer program 13 and/or modules stored in the storage device 11, and calls data stored in the storage device 11 to implement various functions of the testing device 10. The storage device 11 may mainly include a first area for storing computer programs and a second area for storing data, the first area may store an operating system, an application required for at least one function, etc.; the second area may store data created during the running of the server 20. In addition, the storage device 11 may include non-volatile memory, such as hard disk, memory, plug-in hard disk, smart media card (SMC), secure digital (SD) card, flash card, at least one disk storage device, flash memory device, or any other non-transitory storage medium.

If integrated modules/units of the testing device 10 are implemented in the form of software functional units and sold or used as independent products, they can be stored in the external storage medium 40 which is a non-transitory storage medium. Based on this understanding, the present application can implement all or part of the processes in the methods of the above embodiments, which can also be completed by instructing relevant hardware through the computer program 13. The computer program 13 can be stored in the external storage medium 40. When the computer program 13 is executed by the processor 12, it can implement the blocks of each of the above method embodiments.

Among them, the computer program 13 includes computer program code, and the computer program code can be in the form of source code, object code, retrievable files, or some intermediate form.

In some embodiments, as shown in FIG. 1, the storage device 11 of the testing device 10 stores a plurality of instructions to implement the server testing method.

Specifically, the implement of the processor 12 executing the plurality of instructions to implement the server testing method can refer to the corresponding embodiment as shown in FIG. 3, which will not be described again here.

In the several embodiments provided in the present application, it should be understood that the disclosed systems, devices and methods can be implemented in other ways. For example, the device embodiments described above are only illustrative. For example, the division of modules is only a logical function division, and there may be other division methods in actual implementation.

Modules described as separate components may or may not be physically separated, and components shown as modules may or may not be physical units, that is, they may be located in one place, or they may be distributed to multiple network units. Some or all of the modules can be selected according to actual needs to achieve the purpose of the solution of this embodiment.

Each functional module in various embodiments of the present application can be integrated into one unit, or each unit can exist physically alone, or two or more units can be integrated into one unit. The integrated unit can be implemented in the form of hardware or in the form of hardware plus software function modules.

Therefore, the embodiments should be regarded as illustrative and non-restrictive from any point of view, and the scope of the application is defined by the appended claims rather than the above description, and it is therefore intended that all claims falling within the claims. All changes within the meaning and scope of the equivalent elements are included in the present application. Any accompanying reference signs in the claims shall not be construed as limiting the claim in question.

Furthermore, it is clear that the word including does not exclude other elements or blocks, and the singular does not exclude the plural. A plurality units or devices stated in the present application may also be implemented by one unit or device through software or hardware. The words “first”, “second”, etc. are used to indicate names and do not indicate any specific order.

Finally, it should be noted that the above embodiments are only used to illustrate the technical solutions of the present application and are not limiting. Although the present application has been described in detail with reference to the preferred embodiments, those of ordinary skill in the art should understand that the technical solutions of the present application can be modified. Modifications or equivalent substitutions may be made without departing from the spirit and scope of the technical solution of the present application.

What is claimed is:

1. A server testing method, applied to a testing platform, wherein the testing platform is communicatively connected to a server, the server comprises a plurality of processing units and a plurality of switches, the plurality of processing units is interconnected to the plurality of switches according to a topological structure, and the method comprises:
obtaining an updated topological structure by updating the topological structure via updating firmware of the plurality of switches based on a target firmware upgrade package; and
generating a test result by controlling the server to perform a target test task corresponding to the updated topology structure.

2. The server testing method according to claim 1, wherein before updating the firmware of the plurality of switches based on the target firmware upgrade package, the method further comprises:
copying test information to the server, the test information comprising N topology information and N test tasks, each topology information of the N topology information corresponding to one test task of the N test tasks, the N being a positive integer greater than or equal to 1.

3. The server testing method according to claim 2, wherein before updating the firmware of the plurality of switches based on the target firmware upgrade package, the method further comprises:
determining the target firmware upgrade package from N firmware upgrade packages based on a level of a version number corresponding to each of the N firmware upgrade packages.

4. The server testing method according to claim 3, wherein after the server performs the target test task, the method further comprises:
determining whether each of the N firmware upgrade packages has been determined as the target firmware upgrade package;
in response that at least one firmware upgrade package of the N firmware upgrade packages has not been determined as the target firmware upgrade package, determining one of the at least one firmware upgrade package as a current target firmware upgrade package, and obtaining a current updated topological structure by updating current firmware of the plurality of switches based on the current target firmware upgrade package; and
controlling the server to perform a test task among the N test tasks that is corresponding to the current updated topological structure until the firmware of the plurality of switches are updated based on each of all the N firmware upgrade packages and all of the N test tasks have been performed.

5. The server testing method according to claim 2, wherein before copying the test information to the server, the method further comprises:
obtaining the N topology information; and
obtaining the N test tasks by creating one test task corresponding to each of the N topology information in response to user input.

6. The server testing method according to claim 1, wherein before the server performs the target test task, the method further comprises:
determines whether a running environment of the server meets a requirement of a test environment; and
copying an environment configuration tool to the server and installing the environment configuration tool to the server for executing the target test task in response that the running environment of the server does not meet the requirement of the test environment.

7. The server testing method according to claim 1, wherein after the test result is generated, the method further comprises:
saving the testing result; and
evaluating a performance of the server based on the test result.

8. A testing platform, comprising:
a testing device being communicated with a server, the server comprising a plurality of processing units and a plurality of switches, the plurality of processing units being interconnected to the plurality of switches according to a topological structure, the testing device comprises at least one processor and a storage device storing one or more computer programs, which when executed by the at least one processor, cause the at least one processor to:
obtain an updated topological structure by updating the topological structure via updating firmware of the plurality of switches based on a target firmware upgrade package; and
generate a test result by controlling the server to perform a target test task corresponding to the updated topology structure.

9. The testing platform according to claim 8, wherein before the at least one processor is caused to update the firmware of the plurality of switches based on the target firmware upgrade package, the at least one processor is further caused to:
copy test information to the server, the test information comprising N topology information and N test tasks, each topology information of the N topology information corresponding to one test task of the N test tasks, the N being a positive integer greater than or equal to 1.

10. The testing platform according to claim 9, wherein before the at least one processor is caused to update the firmware of the plurality of switches based on the target firmware upgrade package, the at least one processor is further caused to:
determine the target firmware upgrade package from N firmware upgrade packages based on a level of a version number corresponding to each of the N firmware upgrade packages.

11. The testing platform according to claim 10, wherein after the server performs the target test task, the at least one processor is further caused to:
determine whether each of the N firmware upgrade packages has been determined as the target firmware upgrade package;
in response that at least one firmware upgrade package of the N firmware upgrade packages has not been determined as the target firmware upgrade package, determine one of the at least one firmware upgrade package as a current target firmware upgrade package, and obtain a current updated topological structure by updating current firmware of the plurality of switches based on the current target firmware upgrade package; and
control the server to perform a test task among the N test tasks that is corresponding to the current updated topological structure until the firmware of the plurality of switches are updated based on each of all the N firmware upgrade packages and all of the N test tasks have been performed.

12. The testing platform according to claim 9, wherein before the at least one processor is caused to copy the test information to the server, the at least one processor is further caused to:
obtain the N topology information; and
obtain the N test tasks by creating one test task corresponding to each of the N topology information in response to user input.

13. The testing platform according to claim 8, wherein before the server performs the target test task, the at least one processor is further caused to:
determine whether a running environment of the server meets a requirement of a test environment; and
copy an environment configuration tool to the server and install the environment configuration tool to the server for executing the target test task, in responses that the running environment of the server does not meet the requirement of the test environment.

14. The testing platform according to claim 8, wherein after the test result is generated, the at least one processor is further caused to:
save the testing result; and
evaluate a performance of the server based on the test result.

15. A non-transitory storage medium, being stored with one or more computer programs, when the one or more computer programs are executed by a processor of a testing device of a testing platform, the processor is caused to perform a server testing method, wherein the testing platform is communicatively connected to a server, the server comprises a plurality of processing units and a plurality of switches, the plurality of processing units is interconnected to the plurality of switches according to a topological structure, and the server testing method comprises:
obtaining an updated topological structure by updating the topological structure via updating firmware of the plurality of switches based on a target firmware upgrade package; and
generating a test result by controlling the server to perform a target test task corresponding to the updated topology structure.

16. The non-transitory storage medium according to claim 15, wherein before updating the firmware of the plurality of switches based on the target firmware upgrade package, the server testing method further comprises:
copying test information to the server, the test information comprising N topology information and N test tasks, each topology information of the N topology information corresponding to one test task of the N test tasks, the N being a positive integer greater than or equal to 1.

17. The non-transitory storage medium according to claim 16, wherein before updating the firmware of the plurality of switches based on the target firmware upgrade package, the server testing method further comprises:
determining the target firmware upgrade package from N firmware upgrade packages based on a level of a version number corresponding to each of the N firmware upgrade packages.

18. The non-transitory storage medium according to claim 17, wherein after the server performs the target test task, the server testing method further comprises:
determining whether each of the N firmware upgrade packages has been determined as the target firmware upgrade package;
in response that at least one firmware upgrade package of the N firmware upgrade packages has not been determined as the target firmware upgrade package, determining one of the at least one firmware upgrade package as a current target firmware upgrade package, and obtaining a current updated topological structure by updating current firmware of the plurality of switches based on the current target firmware upgrade package; and
controlling the server to perform a test task among the N test tasks that is corresponding to the current updated topological structure until the firmware of the plurality of switches are updated based on each of all the N firmware upgrade packages and all of the N test tasks have been performed.

19. The non-transitory storage medium according to claim 16, wherein before copying the test information to the server, the server testing method further comprises:
obtaining the N topology information; and
obtaining the N test tasks by creating one test task corresponding to each of the N topology information in response to user input.

20. The non-transitory storage medium according to claim 19, wherein before the server performs the target test task, the server testing method further comprises:
determines whether a running environment of the server meets a requirement of a test environment; and
copying an environment configuration tool to the server and installing the environment configuration tool to the server for executing the target test task, in responses that the running environment of the server does not meet the requirement of the test environment.
